(19) United States
(12) Patent Application Publication
(10) Pub. No.: US 2006/0228030 A1
(43) Pub. Date: Oct. 12, 2006

(54) Method and system for image compression for use with scanners

(76) Inventor: Craig E. Hadady, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/102,413

(22) Filed: Apr. 8, 2005

(51) Int. Cl. G06K 9/36

(52) U.S. Cl. 382/232

(57) ABSTRACT

A method and system for compressing scan lines of image data in a first orientation as an image in a second orientation that includes receiving the one or more scan lines of image data in the first orientation, organizing the scan lines into blocks of image data and compressing one or more of the blocks of image data. Each compressed block of image data is dependent upon the preceding compressed block of image data. The dependency of the compressed blocks of image data is interrupted such that the compressed blocks of image data are configured as an image of the second orientation.

### FIELD OF THE INVENTION

The present invention is directed to a method and system relating to the compression of image data generated in a first orientation to form an image in a second orientation, and particularly to the Joint Photographic Expert Group (“JPEG”) standard compression.

### BACKGROUND

Compressors such as a JPEG compressor are routines or software programs that compress data and reduce the storage space required for such data. During JPEG compression, image data may be divided into a two-dimensional array of blocks of image data. Generally, these blocks, called minimum control units (“MCUs”), are eight pixels by eight pixels, or sixty-four pixels in total. An MCU may be represented as a matrix of pixel values. Mathematical operations are performed on the MCU matrices to compress the MCUs. Generally, each MCU matrix may be transformed using the discrete cosine transform (“DCT”) resulting in a matrix of coefficients. The transformed matrix retains all of the image information contained in the original MCU matrix. The top left value of the transformed matrix is known as the DC coefficient. Typically, the DC coefficient for each MCU is stored as the relative difference from the DC coefficient of the MCU to the left of the current MCU, rather than as an absolute value. For the leftmost MCU in a row, the DC coefficient is stored as a relative difference from the DC coefficient of the rightmost MCU in the preceding row. Because of this, MCUs must be processed left to right, top to bottom, so that the original DC coefficient may be recovered during decompression of the image data. After the DCT computation, the transformed matrix of coefficients may be quantized to reduce the number of bits required to store the coefficients. The matrix may be further processed to eliminate image information not discernable to the human eye. The transformed matrix may then be Huffman-encoded resulting in a variable length string of binary digits or bits.

JPEG compression may also be used to compress color images. Color pixel data may be represented using a color space or color model such as RGB or YCbCr to numerically describe the color data. In the YCbCr color space, Y represents the luminance component and Cb and Cr represent individual color components for a pixel. The JPEG compressor may treat the Y, Cb and Cr components as three distinct planes of data and process each set of components separately. In this case, the JPEG compressor will organize the Y, Cb and Cr planes into discrete sets of MCUs and compress the MCUs for each component separately.

Compression techniques such as JPEG compression may be used to store digital images generated using optical scanners. Typically, scanners create digital images by projecting a narrow band of light onto the document to be scanned. The incident light is reflected onto one or more arrays of sensor elements. The sensor elements generate image signal data representative of that portion of the document, generally known as a scan line. A scanner creates a digital image of a document by sampling the sensor elements while moving the band of light along the length of the document generating a series of scan lines, which are assembled to form an image of the document.

It is preferable to compress the scan lines as they are generated rather than waiting for the scanner to complete the scan of the entire document. In general, scan lines are received into a scan buffer during scanning. As used herein, the scan buffer is a reserved segment of memory used for temporary storage and processing of scan lines. After the scan lines are processed by the image processor the processed scan line data is stored in host memory. Compressing scan lines while scan lines are being generated increases the speed of image generation. In addition, if the compressor compresses and stores processed scan line data in host memory while the document is scanned, the scan buffer may be relatively small in comparison to the size of the total image data generated during scanning. Reducing the size of the scan buffer reduces the cost of the scanner.

A problem arises when a scanner that generates scan lines in a first orientation is used to create an image in a second orientation. For example, when a scanner that generates landscape scan lines is used to generate a portrait image. In printing, portrait orientation indicates that data is printed across the narrower side of the form, as in typical text documents. Landscape orientation indicates that data is printed across the wider side of the form. Accordingly, a landscape scan line, as used herein, extends the length of the wider side of the document area. Therefore, the first landscape scan line received in the scan buffer corresponds to the leftmost column of the portrait image. The second scan line corresponds to the second leftmost column and so forth. As discussed above, JPEG compressors process image data starting from the upper left corner and proceeding left to right, top to bottom. Therefore, to generate a portrait image from landscape scan lines, the JPEG compressor may be required to wait until the scan buffer has received all of the scan lines of the image data before beginning compression. Accordingly, there is a need for a method and system for efficient JPEG compression of scan lines of data generated in a first orientation as an image in a second orientation.

### SUMMARY

The method for image compression for use with scanners compresses scan lines of image data in a first orientation as an image in a second orientation. The method includes receiving one or more scan lines of image data in the first orientation, organizing the scan lines into blocks of image data and compressing one or more of the blocks of image data. Each compressed block of image data is dependent upon the preceding compressed block of image data. The dependency of the compressed blocks of image data is interrupted such that the compressed blocks of image data can be configured as an image of the second orientation.

### BRIEF DESCRIPTION OF THE DRAWINGS

FIG. 1 is a plan view of a portrait image on a landscape document;

FIG. 2 is a plan view of the document of FIG. 1 organized as a two dimensional array of blocks of image data by an embodiment of the method for image compression for use with scanners;

FIG. 3 is a plan view of the document of FIG. 1 organized as a two dimensional array of blocks of image data by an alternate embodiment of the method for image compression for use with scanners;

FIG. 4 is a plan view of the document of FIG. 1 organized as a two dimensional array of blocks of image data by a third embodiment of the method for image compression for use with scanners;

FIG. 5 is a flow chart of the image processing logic executed by the compressor of an embodiment of the method for image compression for use with scanners;

FIG. 6 is a flow chart of the image processing logic executed by the compressor of another embodiment of the method for image compression for use with scanners; and

FIG. 7 is a flow chart of the image processing logic executed by the compressor of a third embodiment of the method for image compression for use with scanners.

### DETAILED DESCRIPTION

The method and system for image compression for use with scanners provide for compression of image data generated in a first orientation with a scanner to produce an image in a second orientation. Interrupt codes may be inserted into the image data during compression to create separate, independent subsections of compressed image data. The interrupt code may also pad out or add bits to the end of the compressed image data to ensure that the compressed image data is byte aligned. Byte alignment allows the subsection of the compressed image data to be managed independently of other subsections of the compressed data.

In particular, the method and system may be used with the JPEG compression technique to create JPEG images. The method may use a JPEG compressor and a JPEG restart marker. A restart marker is a utility available in the JPEG standard to disconnect the DC coefficient of the current MCU from the DC coefficient of the preceding MCUs serving as an interrupt code. Restart markers also pad out the compressed data to a byte boundary, ensuring that the compressed data is byte-aligned. Consequently, restart markers break compressed blocks of image data into separate, independent, byte-aligned subsections.

In one embodiment, the JPEG compressor inserts a restart marker after each MCU is compressed. Therefore, the JPEG compressor is able to process each MCU separately, without reference to the preceding MCUs. This allows the JPEG compressor to begin processing MCUs without having to wait to receive all of the scan lines, regardless of the orientation of the image. Compression of an MCU results in a variable length bit string, referred to herein as the MCU compression string. After an MCU is processed generating the MCU compression string, the MCU compression string may be stored in host memory and the portion of the scan buffer containing the scan lines may be released to receive additional scan lines.

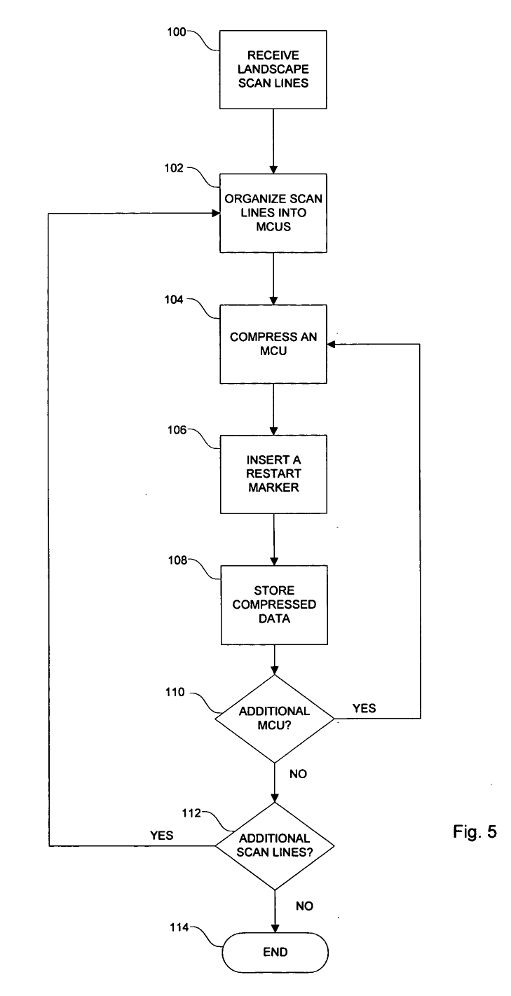

Referring now to FIGS. 1, 2 and 5, a JPEG compressor may insert a restart marker after each MCU to provide for efficient JPEG compression of landscape scan lines to a portrait image. Beginning at step 100 of FIG. 5, landscape scan lines are received into the scan buffer. As discussed above, an MCU is typically an 8×8 array of pixel data. Accordingly, the scan buffer may need to receive eight landscape scan lines before the landscape scan lines may be organized into MCUs. Once the scan buffer contains sufficient landscape scan lines, at step 102 the landscape scan lines are organized into MCUs. The MCUs may be organized from left to right, such that if the compressor needs to add additional information to fill or pad out the MCUs, those MCUs will be located on the right edge of the image. This is important because during decompression the first MCU processed must be filled with actual data rather than data added to pad out the MCU. In this example, the first MCU of the portrait-oriented image corresponds to the upper right MCU of the landscape image data.

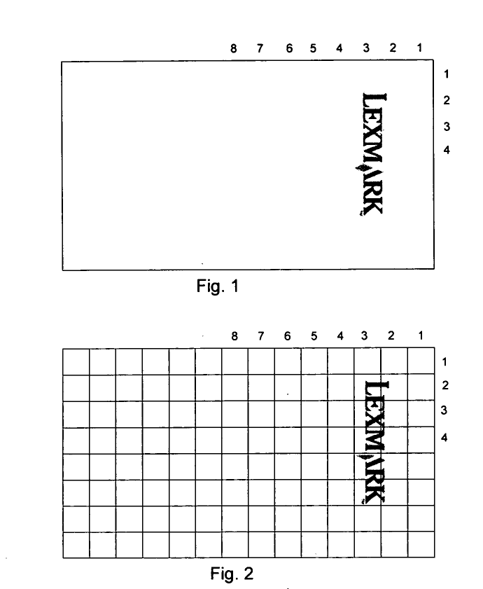

At step 104, the compressor processes a single MCU beginning at the top right MCU, labeled as column 1, row 1 in FIGS. 1 and 2. Prior to performing compression computations, the compressor must reorient the data contained within the MCU matrix so that the compressed MCU string represents the pixels contained within the MCU in the second orientation, in this case portrait orientation. During compression, the compressor may perform a DCT computation on the MCU matrix generating a set of coefficients including the DC coefficient. After DCT computation, the MCU coefficients may be Huffman-encoded to produce the compressed MCU string. At step 106, an interrupt code, such as a JPEG restart marker, may be inserted after the compressed MCU string. The insertion of the JPEG restart marker creates an independent subsection of the compressed image data, pads out the compressed MCU string ensuring that the subsection of compressed image data is byte-aligned and indicates that the next MCU processed will be independent of the preceding MCUs.

At step 108 the subsection of compressed image data is transferred as a bitmap to host memory for later reassembly into a JPEG data file. The portion of the scan buffer containing the scan lines will be released to receive additional landscape scan lines. At step 110, the JPEG compressor will determine if there are additional MCUs to be processed. If there are additional MCUs, the JPEG compressor will return to step 104, otherwise the system will continue to step 112 and determine whether there are additional scan lines in the scan buffer. If there are additional scan lines, the system will return to step 102 to organize the additional scan lines into MCUs. If all of the scan lines have been received and processed, compression terminates at step 114. By inserting a restart marker after each MCU, the system effectively creates a series of independent 8×8 pixel images or bitmaps, illustrated in FIG. 2, which may be reassembled to create the original image.

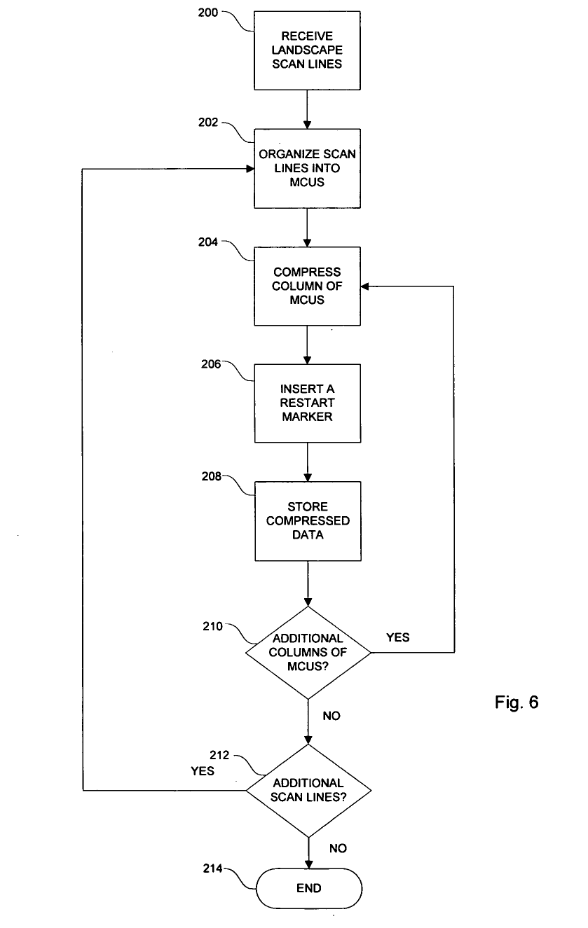

Referring now to FIGS. 3 and 6, in an alternate embodiment the JPEG compressor may process several MCUs prior to inserting the restart marker. As in the previous embodiment, the JPEG compressor creates a series of independent subsections of compressed image data. However, in the previous embodiment these independent subsections contained data for a single MCU. In the present embodiment the subsections may contain an array of MCUs.

The JPEG standard requires that restart markers be evenly distributed throughout image data. Therefore, the number of MCUs included in a subsection will be dependent upon the size of the original image. For example, if the image data is sixteen MCUs high, restart markers may be inserted after every second, fourth or eighth MCU. However, if the height of the image in MCUs is a prime number, restart markers may be inserted only after every MCU or at the end of each column of MCUs.

Beginning at step 200 of FIG. 6, landscape scan lines are received into the scan buffer. Once the scan buffer contains sufficient landscape scan lines, the landscape scan lines are organized into MCUs at step 202. In the example illustrated in FIG. 3, restart markers are inserted after every other MCU. The first sixteen scan lines may be organized as an array of MCUs two columns high spanning the width of the landscape image.

At step 204, the JPEG compressor processes the first two MCUs in the rightmost column (i.e. column 1, row 1 and column 1, row 2). Prior to performing compression computations, the compressor must reorient the data contained within the MCU matrix so that the compressed MCU string represents the pixels contained within the MCU in the second orientation, in this case portrait orientation. During compression the compressor may perform a DCT computation on the MCU matrix generating a set of coefficients including the DC coefficient. After DCT computation, the MCU coefficients may be Huffman-encoded to produce the compressed MCU string. At step 206, an interrupt code, such as a JPEG restart marker, may be inserted after the compressed MCU string. The insertion of the JPEG restart marker creates an independent subsection of the compressed image data, pads out the compressed MCU string ensuring that the subsection of compressed image data is byte-aligned and indicates that the next MCU processed will be independent of the preceding MCUs.

At step 208 the subsection of compressed image data is transferred as a bitmap to host memory for later reassembly into a JPEG data file. The portion of the scan buffer containing the subsection of compressed image data will be released to receive additional landscape scan lines. At step 210, the JPEG compressor will determine if there are additional columns of MCUs to be processed. If there are additional MCUs, the JPEG compressor will return to step 204 to process those columns of MCUs, otherwise the system will continue to step 212 to determine whether there are additional scan lines in the scan buffer. If there are additional scan lines, the system will return to step 202 to organize the additional scan lines into MCUs. If all of the scan lines have been received and processed, the scanning and compression terminates at step 214. By inserting a restart marker after each set of MCUs the system effectively creates a series of independent pixel images as shown in FIG. 3. The pixel images may be reassembled to create the original image.

Alternatively, the JPEG compressor may process sets of MCU columns together. For example, instead of processing the first two MCUs in column 1, inserting a restart marker, processing the first two MCUs in column 2 and so on, the JPEG compressor may process the MCUs in the first row of columns one through eight. Next, the JPEG compressor may process the MCUs in the second row of columns one through eight. To maintain the proper dependencies between the MCUs in each of the columns, the JPEG compressor may generate and store an image context for each column in the set of columns being processed. An image context includes any information necessary to process the next MCU. In particular, the image context includes the DC coefficient for the preceding MCU. Image contexts may be stored in the scan buffer or in a set of registers. For the example illustrated in FIG. 3, for each MCU in the first row, the compressor processes the MCU, generates an image context including the DC coefficient of that MCU and stores the image context. For each MCU in the second row, the compressor retrieves the image context for the appropriate column, compresses the MCU, and inserts a restart marker. The compressor the stores the compressed MCU strings for the first set of MCUs and proceeds to process the next set of MCUs.

The JPEG compressor may also generate and store a machine context when processing sets of MCUs. A machine context includes information necessary for the JPEG compressor to track compression of the MCUs. For example, the machine context may include information indicating which rows in a column have been processed. When processing MCUs in sets, the compressor is able to perform a single read operation to retrieve the set of MCUs rather than performing an individual read operation for each MCU. Consequently, processing MCUs in sets may reduce processing time.

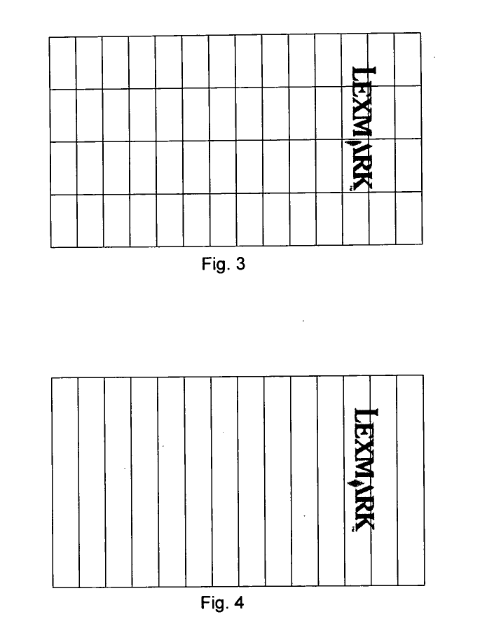

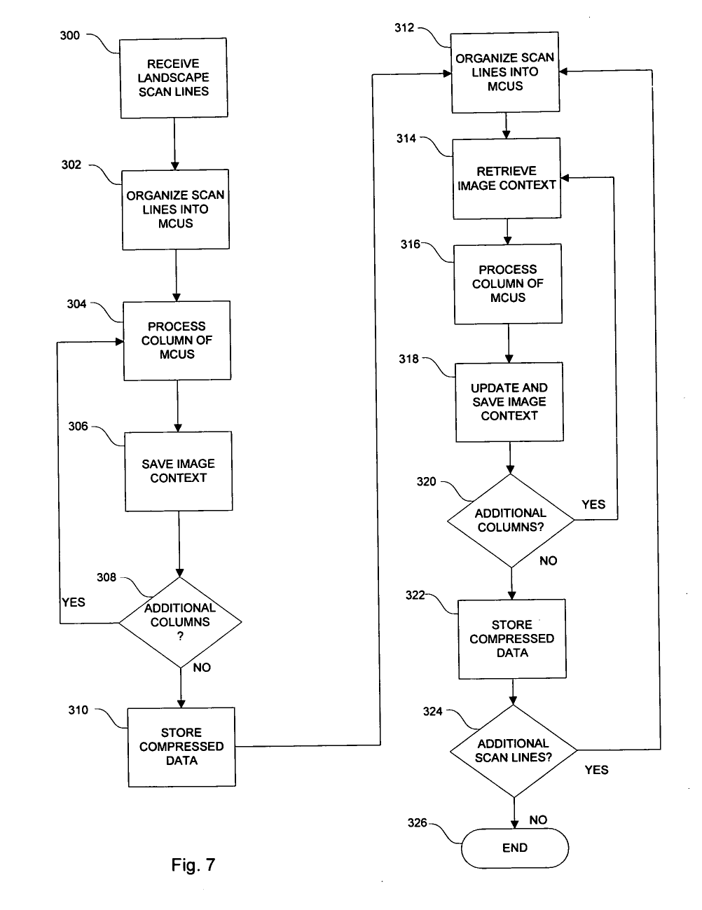

Referring now to FIG. 7, in a third embodiment the system may use image contexts to minimize the number of restart markers required. Using image contexts, the compressor may process the scan lines and issue restart markers only at the end of each column to create the independent subsections illustrated in FIG. 4. The compressor may also utilize machine contexts to track the progress through the MCUs. Beginning at step 300, the system receives landscape scan lines into the scan buffer. After the system has received sufficient scan lines, the scan lines are organized into MCUs at step 302. For example, the system may receive thirty-two scan lines. These scan lines can be organized as a two dimensional array of MCUs four MCUs in height and equal to the width of the landscape scan line. At step 304, the system processes and compresses a column of MCUs. The system will start at the far right with column 1 and process the four MCUs in column 1 from top to bottom. At step 306, the compressor creates an image context including all of the information necessary to compress the next MCU of column 1 and saves the image context in the scan buffer. The compressor may also create a machine context indicating which rows have been compressed and store the machine context in the scan buffer. Next, the compressor is initialized so that it is ready to process the next column. At step 308, the compressor determines if there are additional columns to process. If there are additional columns of MCUs, the compressor returns to step 304 to process the next column. Once all of the columns within the two dimensional array of MCUs have been processed, the compressor will store the compressed MCU strings in host memory at step 310.

The compressor organizes additional scan lines into MCUs at step 312. At step 316, the compressor retrieves the appropriate image context for the MCU column from the scan buffer. The compressor may also retrieve the appropriate machine context. The compressor will use the data in the image context to process and compress the column MCUs at step 316. If the MCU is the last MCU in that column in the image, the compressor will insert a restart marker. At step 318, the compressor updates the image context based upon the most recently processed MCU and stores the updated image context in the scan buffer. At step 320, the compressor determines if there are additional columns that require processing and returns to step 314 if necessary. If all of the columns have been processed, the compressor stores the compressed MCU strings in host memory at step 322. At step 324, the compressor determines if there are additional scan lines to process and returns to step 312, if necessary. If all the scan lines have been processed, compression terminates at step 326. Storing and retrieving image contexts allows the compressor insert restart markers only at the end of each column of MCUs. Since each restart marker is two bytes in length, reducing the number of restart markers inserted into the compressed image data decreases the total file size of the final image.

In addition, each of the foregoing methods and systems may be applied to color image data. As discussed above, the JPEG compressor processes the color image components as separate planes of data. Accordingly, the embodiments described above may be utilized during compression of the individual planes of data.

The foregoing description of several methods and systems of the invention has been presented for the purposes of illustration. It is not intended to be exhaustive or to limit the invention to the precise procedures disclosed, and obviously many modifications and variations are possible in light of the above teaching. It is intended that the scope of the invention be defined by the claims appended hereto.

What is claimed is:

1. A method for compressing one or more scan lines of image data in a first orientation as an image in a second orientation comprising:
receiving the one or more scan lines of image data in the first orientation;
organizing the one or more scan lines into blocks of image data;
compressing the one or more of the blocks of image data, wherein each compressed block of image data is dependent upon the preceding compressed block of image data;
interrupting the dependency of the compressed blocks of image data; and
configuring the compressed blocks of image data as an image in the second orientation.

2. The method of claim 1, wherein interrupting the dependency of the compressed blocks of image data includes inserting an interrupt code.

3. The method of claim 2, wherein an interrupt code is inserted after each compressed block of image data.

4. The method of claim 1, wherein the compressed blocks of image data are byte aligned.

5. The method of claim 1, wherein compressing the one or more blocks of image data is performed using a JPEG compressor.

6. The method of claim 5, wherein interrupting the dependency of the compressed blocks of image data includes inserting a JPEG restart marker.

7. The method of claim 5, wherein the blocks of image data are JPEG minimum coded units.

8. The method of claim 6, wherein the JPEG restart marker is inserted after each compressed block of image data.

9. The method of claim 1, further comprising storing the compressed blocks of image data and reassembling the compressed blocks of image data to form the image in the second orientation.

10. The method of claim 1, further comprising:
generating an image context for one or more compressed blocks of image data, wherein the image context includes dependency information;
storing the image context;
retrieving the image context; and
compressing a block of image data utilizing the image context.

11. The method of claim 10, wherein compressing the block of image data utilizing the image context includes performing a discrete cosine transformation and the image context includes a DC coefficient.

12. The method of claim 1, wherein the one or more scan lines of image data includes color image data.

13. A method for compressing one or more scan lines of image data in a first orientation as an image in a second orientation comprising:
receiving the one or more scan lines of image data in the first orientation;
organizing the one or more scan lines into JPEG minimum coded units;
compressing the one or more JPEG minimum coded units using a JPEG compressor, wherein each compressed JPEG minimum coded unit is dependent upon the preceding compressed JPEG minimum coded unit;
inserting a JPEG restart marker after the one or more JPEG minimum coded units to interrupt the dependency of the JPEG minimum coded units; and
configuring the compressed JPEG minimum coded units as an image in the second orientation.

14. The method of claim 13 further comprising:
generating an image context for one or more JPEG minimum coded units, wherein the image context includes dependency information;
storing the image context;
retrieving the image context; and
compressing a JPEG minimum coded unit utilizing the image context.

15. The method of claim 14, wherein compressing the JPEG minimum coded unit utilizing the image context includes performing a discrete cosine transformation and the image context includes a DC coefficient.

16. The method of claim 13, wherein the one or more scan lines of image data includes color image data.

17. A system for compressing one or more scan lines of image data in a first orientation as an image in a second orientation comprising:
a scan buffer for receiving the one or more scan lines of image data in the first orientation;
a compressor for organizing the scan lines into blocks of image data, compressing the one or more of the blocks of image data, wherein each compressed block of image data is dependent upon the preceding compressed block of image data and interrupting the dependency of the compressed blocks of image data; and
a memory for storing the compressed blocks of image data configured as an image in the second orientation.

18. The system of claim 17, wherein the compressor inserts one or more interrupt codes to interrupt the dependency of the compressed blocks of data.

19. The system of claim 18, wherein the compressor is a JPEG compressor and the one or more interrupt codes are JPEG restart markers.

20. The system of claim 17, wherein the compressed blocks of image data are reassembled to form the image in the second orientation.
